(19) United States
(12) Patent Application Publication
(10) Pub. No.: US 2008/0217327 A1
(43) Pub. Date: Sep. 11, 2008

(54) Portable cooking and heating device

(76) Inventor: Charles E. Herrera, Pueblo West, CO (US)

Correspondence Address: JAMES RAY & ASSOCIATES, 2640 PITCAIRN ROAD, MONROEVILLE, PA, 15146, US

(21) Appl. No.: 12/069,078

(22) Filed: Feb. 7, 2008

Related U.S. Application Data
(60) Provisional application No. 60/888,550, filed on Feb. 7, 2007.

(51) Int. Cl. H05B 6/68; H05B 6/76; H05B 6/00; H05B 6/64

(52) U.S. Cl. 219/717; 219/739; 219/756; 219/719; 219/720

(57) ABSTRACT

A portable cooking and heating device includes a housing and an inner chamber for receiving at least one of heatable products, heat, and microwave energy, such inner chamber being located within the housing at a predetermined location therein adjacent an outer periphery thereof. An access means provides access to such inner chamber. A mechanism is disposed within the housing for supplying at least one of heat and microwave energy to at least one of the inner chamber and such heatable products such that such heatable products are at least one of at least partially cooked and at least partially heated. A power source is operably connected to such mechanism for supplying at least one of heat and microwave energy for supplying power thereto. A handle member for carrying the device is operably connected to a predetermined location on an outer surface of the housing.

### CROSS REFERENCE TO RELATED APPLICATION

This patent application is related to and claims priority from U.S. Provisional Patent Application Ser. No. 60/888,550 filed Feb. 7, 2007.

### FIELD OF THE INVENTION

The present invention relates, in general, to cooking and heating devices and, more particularly, this invention relates to portable microwave ovens.

### BACKGROUND OF THE INVENTION

Prior to the conception and development of the present invention, microwave ovens, as are generally well known in the prior art, have been used in homes to heat food and other products but are not available to persons traveling in an automobile, camping, picnicking, and the like.

Specifically of interest to the present invention are the following: Schimizu, et al, U.S. Pat. No. 6,693,267, provides a portable microwave oven, formed by a hollow prismatic body defining an internal cooking chamber having a tiltable door that gives access to the cooking chamber, the cooking chamber being provided with a first and second product supporting surface.

Kim, et al, U.S. Pat. No. 6,153,869, provides an AC/DC type microwave oven which has a function of managing an input power source. The AC/DC type microwave oven comprises a rotatable inverter which inverts a DC power source to an AC power source by a high voltage transformer.

Lowe, et al, U.S. Pat. No. 5,276,300, provides a microwave oven described as suitable for use on transports where DC power is available. When external AC line power is no longer applied, the microwave oven automatically switches to operate from the available DC power. An efficient cooling fan is provided that is driven by a DC motor.

### SUMMARY OF THE INVENTION

The present invention provides a portable cooking and heating device. Such device includes a housing, manufactured from a first predetermined material and having a first predetermined size and a first predetermined shape. An inner chamber for receiving at least one of heatable products, heat, and microwave energy is located within such housing at a predetermined location therein adjacent an outer periphery thereof. An access means for providing access to such inner chamber is operably connected to at least one of such inner chamber and such housing at a predetermined location thereon. A means is disposed within such housing for supplying at least one of heat and microwave energy to at least one of such inner chamber and such heatable products such that such heatable products are at least one of at least partially cooked and at least partially heated. A power source is operably connected to the means for supplying at least one of heat and microwave energy, for supplying power thereto. A handle member for carrying the device is operably connected to a predetermined location on an outer surface of such housing.

Another embodiment of the invention provides, in combination with a microwave oven having a microwave energy source, the improvement comprising at least one battery operably and removably connected to the microwave energy source for supplying power thereto, thereby enabling the microwave oven to be portable.

### OBJECTS OF THE INVENTION

It is, therefore, one of the primary objects of the present invention to provide a portable cooking and heating device which is easy to transport.

Another object of the present invention is to provide a portable cooking and heating device which may operate from battery power if electrical power from a conventional electrical outlet is not available.

Still another object of the present invention is to provide a travel-sized microwave oven which may be powered by a battery which may be rechargeable.

Yet another object of the present invention is to provide a travel-sized microwave with rounded edges for safety and a convenient carrying case for easy transport.

An additional object of the present invention is to provide a portable cooking and heating device that can be used anywhere.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention in which the access means is a door.

FIG. 3 is a partial perspective view of the invention according to one embodiment of the invention in which the control means includes a digital display.

FIG. 4 is a partial schematic view of the invention according to one embodiment of the invention.

FIG. 5 is a partial perspective view of the invention according to one embodiment of the invention in which the invention includes a carrying case.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

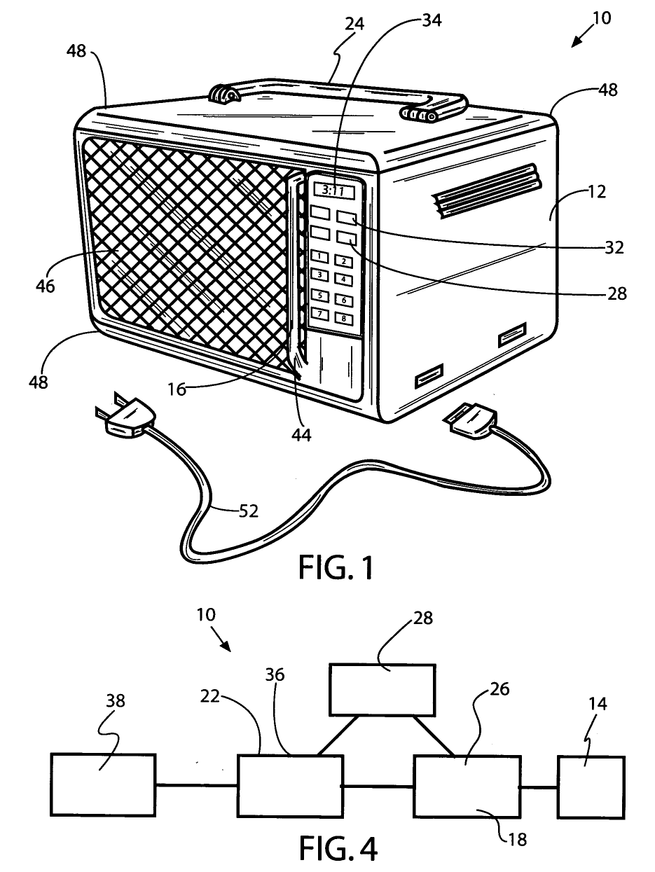

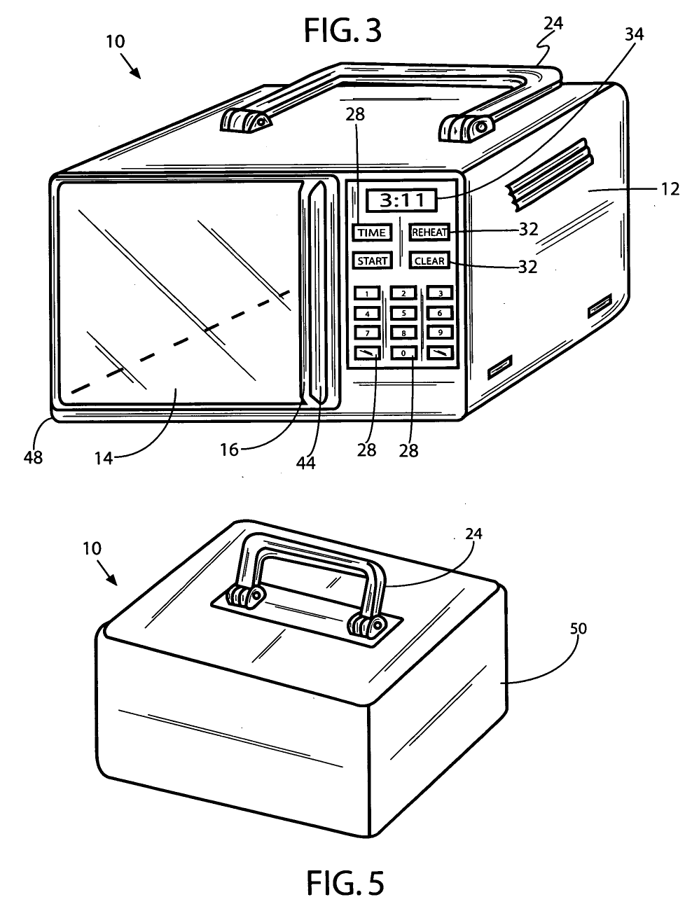

Reference is now made, more particularly, to FIGS. 1-5.

A portable cooking and heating device, generally designated 10, is provided. Such device 10 includes a housing 12, manufactured from a first predetermined material and having a first predetermined size and a first predetermined shape.

An inner chamber 14 for receiving at least one of heatable products, heat, and microwave energy is located within the housing 12 at a predetermined location therein adjacent an outer periphery thereof.

An access means 16 for providing access to such inner chamber 14 is operably connected to at least one of such inner chamber 14 and the housing 12 at a predetermined location thereon.

A means 18 is disposed within the housing 12 for supplying at least one of heat and microwave energy to at least one of such inner chamber 14 and such heatable products such that such heatable products are at least one of at least partially cooked and at least partially heated.

A power source 22 is operably connected to the means 18 for supplying at least one of heat and microwave energy, for supplying power thereto.

A handle member 24 for carrying the device 10 is operably connected to such housing a predetermined location on an outer surface thereof. It is presently preferred that such handle member 24 includes a movement mechanism such that such handle member can be moved between a substantially vertical position and a substantially horizontal position. It is presently preferred that such handle member 24 include at least one hinge to facilitate such movement.

It is presently preferred that the device 10 is between about 9.0 inches and 11.0 inches long, between about 6.0 inches and 8.0 inches wide, and between about 4.5 inches and 7.5 inches deep.

It is further presently preferred that the means 18 for supplying at least one of heat and microwave energy is a microwave energy source 26 and the device 10 further includes a means for preventing microwave energy from escaping from the housing 12 when the microwave energy source 26 produces microwave energy.

It is additionally presently preferred that the power source 22 further includes a control means 28, operably connected thereto at a predetermined location thereon and disposed on an outer periphery of the housing 12 at a predetermined location thereon, such that a user can control at least one of the supplying of heat and the supplying of microwave energy in terms of at least one of level of heat supplied, level of microwave energy supplied, duration of heating, and duration of microwave energy transmission.

It is also presently preferred that such control means 28 includes a plurality of predetermined settings 32 for such user to choose from such that such heatable product will be heated for a predetermined amount of time at a predetermined heating level according to which setting such user chooses to implement.

It is further presently preferred that such control means 28 includes a digital display 34 for indicating predetermined information. It is presently preferred that such predetermined information includes information relating to at least one of time of day, cooking instructions, heating instructions, cooking time, and heating time.

It is presently preferred that the power source 22 is at least one of AC and DC power.

It is presently preferred that the power source 22 is DC and the device 10 further includes at least one battery 36 operably connected to the microwave energy source 26 and removably secured within the housing 12 at a predetermined location therein.

It is presently preferred that such at least one battery 36 is rechargeable and that the device 10 further includes a means 38 for recharging such at least one battery 36. When using DC power the device 10 includes an inverter for converting DC power to AC power. The device 10 may be capable of receiving power from an automotive battery via use of a adapter 42 which could also serve as a charger being capable of charging a rechargeable battery.

It is presently preferred that the access means 16 is a door 44 operably connected to the housing 12 at a predetermined location thereon, such door 44 further including a means 46 for preventing microwave energy from escaping from the housing 12 when such microwave energy source 26 produces microwave energy.

It is presently preferred that the device 10 includes at least one rounded portion 48 at a predetermined location on an outside surface thereof. It is presently most preferred that the outside edges of the housing 12 be rounded for safety purposes.

It is additionally presently preferred that the device 10 further includes a carrying case 50 in which the portable cooking and heating device 10 fits for protecting the device 10 during at least one of storage and transportation, as illustrated in FIG. 5. Such carrying case 50 being manufactured from a second predetermined material and having a second predetermined size and a second predetermined shape.

Referring to FIG. 1, according to another embodiment of the invention, such power source is AC and the device 10 further includes an electrical cord 52 for communicating electricity to such microwave energy source. The electrical cord 52 being operably connected to such microwave energy source at a first predetermined end thereof and removably and operably connectable to an electrical outlet at a second predetermined end thereof for receiving electricity therefrom.

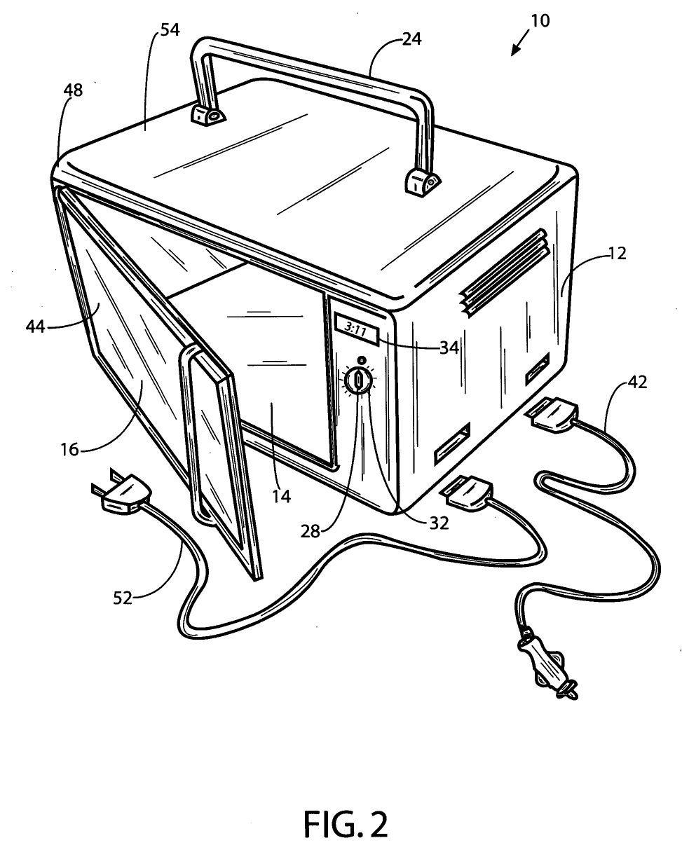

Referring to FIG. 2 and FIG. 4, according to yet another embodiment of the invention, in combination with a microwave oven 54 having a microwave energy source 26, the improvement comprising at least one battery 36 operably and removably connected to such microwave energy source for supplying power thereto, thereby enabling such microwave oven 54 to be portable. When using DC power the device includes an inverter for converting DC power to AC power.

It is presently preferred that such at least one battery 36 is an automotive battery, however, such at least one battery may be any type of battery known in the art. Such automotive battery may supply power to the device via an adapter 42 which could also be capable of charging a rechargeable battery from the automotive battery.

It is also presently preferred that such microwave oven is between about 9.0 inches and 11.0 inches long, between about 6.0 inches and 8.0 inches wide, and between about 4.5 inches and 7.5 inches deep.

It is further presently preferred that such microwave oven further includes a handle member 24 for carrying such microwave oven, the handle member being operably connected to a predetermined location on an outer surface of the microwave oven.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A portable cooking and heating device comprising:
a. a housing, manufactured from a first predetermined material and having a first predetermined size and a first predetermined shape;
b. an inner chamber for receiving at least one of heatable products, heat, and microwave energy, said inner chamber being located within said housing at a predetermined location therein adjacent an outer periphery thereof;
c. an access means for providing access to said inner chamber operably connected to at least one of said inner chamber and said housing at a predetermined location thereon;
d. a means disposed within said housing for supplying at least one of heat and microwave energy to at least one of said inner chamber and such heatable products such that such heatable products are at least one of at least partially cooked and at least partially heated;
e. a power source operably connected to said means for supplying at least one of heat and microwave energy, for supplying power thereto; and
f. a handle member for carrying said device, said handle member being operably connected to such housing at a predetermined location on an outer surface thereof.

2. A portable cooking and heating device according to claim 1 wherein said handle member includes a movement mechanism such that said handle member can be moved between a substantially vertical position and a substantially horizontal position.

3. A portable cooking and heating device according to claim 1 wherein said device is between about 9.0 inches and 11.0 inches long, between about 6.0 inches and 8.0 inches wide, and between about 4.5 inches and 7.5 inches deep.

4. A portable cooking and heating device according to claim 1 wherein said means for supplying at least one of heat and microwave energy is a microwave energy source and said device further includes a means for preventing microwave energy from escaping from said housing when said microwave energy source produces microwave energy.

5. A portable cooking and heating device according to claim 4 wherein said power source further includes a control means operably connected thereto at a predetermined location thereon and disposed on an outer periphery of said housing at a predetermined location thereon such that a user can control at least one of the supplying of heat and the supplying of microwave energy in terms of at least one of level of heat supplied, level of microwave energy supplied, duration of heating, and duration of microwave energy transmission.

6. A portable cooking and heating device according to claim 5 wherein said control means includes a plurality of predetermined settings for such user to choose from such that said heatable product will be heated for a predetermined amount of time at a predetermined heating level according to which setting such user chooses to implement.

7. A portable cooking and heating device according to claim 6 wherein said control means includes a digital display for indicating predetermined information.

8. A portable cooking and heating device according to claim 7 wherein said predetermined information includes information relating to at least one of time of day, cooking instructions, heating instructions, cooking time, and heating time.

9. A portable cooking and heating device according to claim 1 wherein said power source is at least one of AC and DC power.

10. A portable cooking and heating device according to claim 9 wherein said power source is AC and said device further includes an electrical cord for communicating electricity to said microwave energy source said electrical cord being operably connected to said microwave energy source at a first predetermined end thereof and removably and operably connectable to an electrical outlet at a second predetermined end thereof for receiving electricity therefrom.

11. A portable cooking and heating device according to claim 9 wherein said power source is DC and said device further includes at least one battery operably connected to said microwave energy source and removably secured within said housing at a predetermined location therein.

12. A portable cooking and heating device according to claim 11 wherein said at least one battery is rechargeable.

13. A portable cooking and heating device according to claim 12 wherein said portable cooking and heating device further includes a means for recharging said at least one battery.

14. A portable cooking and heating device according to claim 4 wherein said access means is a door operably connected to said housing at a predetermined location thereon, said door further including a means for preventing microwave energy from escaping from said housing when said microwave energy source produces microwave energy.

15. A portable cooking and heating device according to claim 1 wherein said device includes at least one rounded portion at a predetermined location on an outside surface thereof.

16. A portable cooking and heating device according to claim 1 wherein said portable cooking and heating device further includes a carrying case in which said portable cooking and heating device fits for protecting said portable cooking and heating device during at least one of storage and transportation, said carrying case being manufactured from a second predetermined material and having a second predetermined size and a second predetermined shape.

17. In combination with a microwave oven having a microwave energy source, the improvement comprising at least one battery operably and removably connected to said microwave energy source for supplying power thereto thereby enabling said microwave oven to be portable.

18. The device according to claim 17 wherein said at least one battery is an automotive battery.

19. The device according to claim 17 wherein said microwave oven is between about 9.0 inches and 11.0 inches long, between about 6.0 inches and 8.0 inches wide, and between about 4.5 inches and 7.5 inches deep.

20. The device according to claim 17 wherein said microwave oven further includes a handle member for carrying said microwave oven, said handle member being operably connected to a predetermined location on an outer surface of said microwave oven.
